(19) United States
(12) Patent Application Publication
(10) Pub. No.: US 2014/0046574 A1
(43) Pub. Date: Feb. 13, 2014

(54) ENGINE CONTROL USING AN ASYNCHRONOUS DATA BUS

(71) Applicants: DARWIN SPENCER EISENBARTH, Sagle, ID (US); Michael Wittkopf, El Paso, TX (US); Jeffrey David Greene, Aliso Viejo, CA (US); Eitan Lavi, El Paso, TX (US)

(72) Inventors: DARWIN SPENCER EISENBARTH, Sagle, ID (US); Michael Wittkopf, El Paso, TX (US); Jeffrey David Greene, Aliso Viejo, CA (US); Eitan Lavi, El Paso, TX (US)

(73) Assignee: AUTOTRONIC CONTROLS CORPORATION

(21) Appl. No.: 13/570,041

(22) Filed: Aug. 8, 2012

(51) Int. Cl. F02D 41/34; F02D 41/26

(52) U.S. Cl. 701/105; 701/103

(57) ABSTRACT

An engine control unit with distributed processing includes a main ECU and remote modules with sensor inputs and ignition and injector outputs. A bidirectional asynchronous CAN data bus and a square wave timing signal operatively connect the components. Synchronous ignition and ignition data and asynchronous sensor and control data are concurrently transmitted between components using CAN messaging. Synchronicity is accomplished using the timing signal. The rising edge of each pulse triggers dwell and injection start times, and the falling edge triggers ignition. Injection and dwell time values, the cylinders to dwell and fire, and the injectors to energize, are transmitted using CAN messaging. The remote modules process the control messages and timing signal and generate the appropriate ignition, injector, and pulse width modulation control signals. Alternatively, time stamp capabilities of the CAN bus topology are used for synchronization. The system and methodology simplify interconnection, using fewer wires and enhancing aesthetics.

### BACKGROUND OF THE INVENTION

1. Field of the Invention

This invention relates generally to engine control systems for internal combustion engines, and in particular to a control bus for communication between electronic engine control components.

2. Background Art

A carburetion fuel delivery system uses a carburetor to supply and meter the mixture of fuel and air in relation to the speed and load of the engine. Variations in atmospheric temperature and pressure, engine temperature, load and speed make perfect carburetion nearly impossible to obtain under all driving conditions. In contrast, fuel injection systems meter fuel much more precisely than carburetors, thereby allowing optimal fuel-air mixture to be more consistently delivered across the full spectrum of driving conditions. Fuel injection provides increased horsepower, higher torque, improved fuel economy, quicker cold starting, and other benefits. As a result, fuel injection systems have largely replaced carburetion fuel delivery systems in automobiles manufactured after 1985.

Fuel injection systems use one or more fuel injectors, which are electromechanical devices that meter and atomize fuel. In each injector, application of an electrical current to a coil lifts a spring-loaded needle within a pintle valve off its seat, thereby allowing fuel under pressure to be sprayed through an injector nozzle to form a cone pattern of atomized fuel. Fuel may be injected into the throttle body (throttle body injection), into one or more ports in the induction manifold (port injection), or directly into the cylinders (direct injection).

A fuel injection engine requires a control system that determines when and for how long to actuate various fuel injectors in proper relation to the engine's ignition sequence. Electronic control is the most common manner for governing the rate of fuel injection and is commonly known as electronic fuel injection (EFI). A microprocessor- or microcontroller-based computer system, commonly known as an engine control unit (ECU), controls fuel injection and typically other various engine and automotive systems, including ignition, as preprogrammed functions of numerous signals received from various sensors. For control of fuel injection, the computer generates periodic pulse signals for each of the injectors, with “on” pulses for firing the fuel injectors. The cycle wavelength is a function of engine speed, and the pulse widths of the “on” pulses are a function of engine load. Engine speed is typically determined by a distributor output, a tachometer output, or a crankshaft sensor. Engine load is typically determined with either a mass airflow sensor or a manifold absolute pressure (MAP) sensor. One or more driver circuits amplify and condition the pulse signals to be suitable for use with the fuel injectors.

There are a number of enthusiasts who operate vintage automobiles, often muscle cars, hotrods, and the like, who would benefit from upgrading the original carburetion fuel delivery systems with fuel injection systems. A carbureted engine can be retrofitted with and derive performance advantages a fuel injection system, whether it be a throttle body injection, a port injection, or a direct injection system. Because most modern fuel injection systems are direct or port injection, in some cases cost benefits may be obtained by retrofitting with one of these prolific modern systems rather than a throttle body system, particularly in the case of installation on a more modern engine.

To minimize cost on modern fuel injection systems, original equipment manufacturers (OEM) of automobile collocate the ECU microprocessor and driver circuits in a single assembly, often on a single printed circuit board. The numerous control outputs to the engine and sensor inputs from the engine and associated systems are routed within a large harness assembly. Accordingly, retrofitting a carbureted engine with a modern port or direct injection system always comes at the expense of increased complexity.

There is a desire, however, to maintain the traditional clean look, feel, and simplicity of a carburetor mounted atop the intake manifold, with a minimal amount of fuel piping and electrical harnessing. Throttle body fuel injection systems are ideal for the retrofit market, because they are a direct bolt-on replacement for a carburetor. Accordingly, a niche market has evolved for kits to adapt existing carburetors with injection capability or to replace existing carburetors with bolt-in-place throttle body fuel injection systems. Although such retrofit products exist, which provide many benefits of fuel injection, there is room for improvement in the control system arrangement and operation.

For example, with aftermarket fuel injection retrofit products, it is desirable for aesthetic reasons to separate the ECU main processor from injector and ignition drivers, power drivers, and various sensor inputs, thereby allowing a smaller ECU to be located at the throttle body assembly and minimizing the number of wires required between the ECU and the engine. That is, with a decentralized-processing ECU, the input/output (I/O) circuitry can be relocated away from the microprocessor and instead carried by a separate printed circuit board mounted to the engine, thereby reducing the size of the wiring harness and complexity for the installer.

Unlike a conventional ECU, with a decentralized-processing ECU, the bus that interconnects the microprocessor to the I/O circuitry no longer resides on a single printed circuit board but instead forms a part of the ECU harness. It is desirable to minimize the size and number of wires within the ECU harness, both for aesthetic reasons and to simply installation for the do-it-yourself hobbyist market. However, difficulty in minimizing the number of conductors in the ECU harness stems from the fact that ignition and injector sequence timing must be precisely and accurately controlled in relation to the crankshaft position in real time.

Existing automotive bus standards, such as controller area network (CAN), have largely replaced conventional wiring harnesses that interconnect components using large numbers of discrete point-to-point connections. Although such existing automotive buses are ideal for connecting ECUs to various sensors, they are ill-suited for engine ignition and injection control, because they are non-deterministic in nature, having unpredictable propagation times. According to conventional design logic, therefore, a engine control bus in decentralized ECU would be a dedicated real-time bus with discrete point-to-point connections. For a V-8 engine, there would be, at a minimum, eight conductors for injectors, eight conductors for ignition, a signal ground, power conductors, and two or more conductors for sensor I/O.

It is desirable, therefore, to provide an engine control bus for a decentralized ECU that adapts existing asynchronous CAN bus technology so as to be capable of providing synchronized ignition and injection control on the same bus concurrently with event-driven and non-real-time periodic data from sensors and for control various devices, thereby greatly reducing the number of conductors in the engine control harness.

3. Identification of Objects of the Invention

A primary object of the invention is to provide a decentralized ECU for engine control with superior aesthetic appeal.

Another object of the invention is to provide a ECU for engine control with a reduced number of wires interconnecting components for simplicity of installation, maintenance, diagnostics, and aesthetics.

Another object of the invention is to provide a method and apparatus for engine ignition and fuel injection control bus for a decentralized ECU that adapts existing asynchronous CAN bus technology so as to be capable of providing synchronized ignition and injection control on the same bus concurrently with event-driven and non-real-time periodic data from sensors and for control various devices.

### SUMMARY OF THE INVENTION

The objects described above and other advantages and features of the invention are incorporated in a decentralized EFI ECU system with distributed processing. The system includes a main ECU module and left and right bank remote input/output modules. Each remote module preferably includes input channels for sensor inputs, ignition outputs, fuel injector outputs, and pulse width modulation outputs, which may be used for electronic throttle control, variable valve timing, or idle air motor actuation, for example. A bidirectional ECU control bus operatively connects the main ECU to the remote modules.

The remote modules receive input signals from various engine sensors and encode the sensor data into corresponding sensor data structures, or messages. The sensor input messages are in turn transmitted via a bi-directional CAN data bus (or similar asymmetric data bus) from the remote modules to the main ECU. The main ECU, which also receives engine position data directly from crank and cam signal inputs, processes this data and generates required control data structures, or messages and an output timing signal. The control messages are transmitted via the bi-directional CAN data bus and the timing signal is transmitted via a separate timing conductor back to the remote modules. The remote modules process the control messages and timing signal and generate the appropriate ignition, injector, and pulse width modulation control signals for engine operation.

The control protocol includes a synchronous protocol, which is used to control ignition and fuel injection and is synchronized to the rotation of the engine (using crank and cam signal inputs) via the timing synchronization signal, and an asynchronous protocol, which may be either time-driven or event-driven. The time-driven messages are used to scan the sensor inputs and to update the various pulse width modulation outputs at the remote modules. Event-based messages are used for special purposes such as accelerator pump functions. The asynchronous protocol uses only CAN data without need of the timing synchronization signal.

In a first embodiment, synchronicity using the CAN data bus is accomplished using the associated timing signal, which consists of a periodic square wave pulse signal. The rising edge of each pulse serves as a trigger from which dwell, and injection are timed. The particular time values for injection and dwell, as well as which cylinder to dwell and which injectors to energize, are transmitted over the CAN bus in the control messages. The falling edge of each pulse serves as a trigger for firing ignition. The particular cylinders to fire are communicated in the control messages via the CAN bus. The remote modules process the control messages and timing signal and generate the appropriate ignition, injector, and pulse width modulation control signals.

In a second embodiment, the need for the timing signal to ensure synchronicity is eliminated. Only the CAN messaging is used. This embodiment uses time stamp capabilities of the CAN bus topology to synchronize the main ECU with the remote modules. The main ECU sends two timing messages to the remote modules. The first timing message sent is the sync command. When the sync command is sent, the CAN hardware creates a first time stamp of the exact time the message was sent by the main ECU and a separate time stamp of when the message was received by each of the remote modules. The main ECU then sends a second timing message containing the first time stamp data that was generated on the transmission of the sync command. The remote modules each compare the first time stamp data in the second message from the main ECU and their own time stamp data generated when the sync command was received. The difference between the two time stamps is then used to synchronize the time base of the remote modules to the main ECU.

Once the main ECU and remote modules are synchronized, the main ECU can then issue injector and ignition commands, including the specific clock time at which to execute the commands, to the remote modules. This synchronization process is repeated periodically to correct for any drift in the clock timing between the main ECU and remote modules.

### BRIEF DESCRIPTION OF THE DRAWINGS

The invention is described in detail hereinafter on the basis of the embodiments represented in the accompanying figures, in which:

FIG. 1 is a functional block diagram of a decentralized engine control system according to a preferred embodiment of the invention, showing a main ECU for mounting to a throttle body interconnected with left and right bank remote modules via a novel and inventive engine control bus;

FIG. 2 is a simplified functional block diagram of the engine control system of FIG. 1, showing detail of the engine control bus including an asymmetric CAN data bus and a timing signal conductor;

FIG. 3 is a simplified wiring harness schematic of the engine control bus of FIGS. 1 and 2; and

FIG. 4 is a diagram of a timing synchronization signal waveform according to a preferred embodiment of the invention for transmission over the timing signal conductor and in association with control data for transmission the CAN data bus of FIG. 2.

### DESCRIPTION OF THE PREFERRED EMBODIMENT OF THE INVENTION

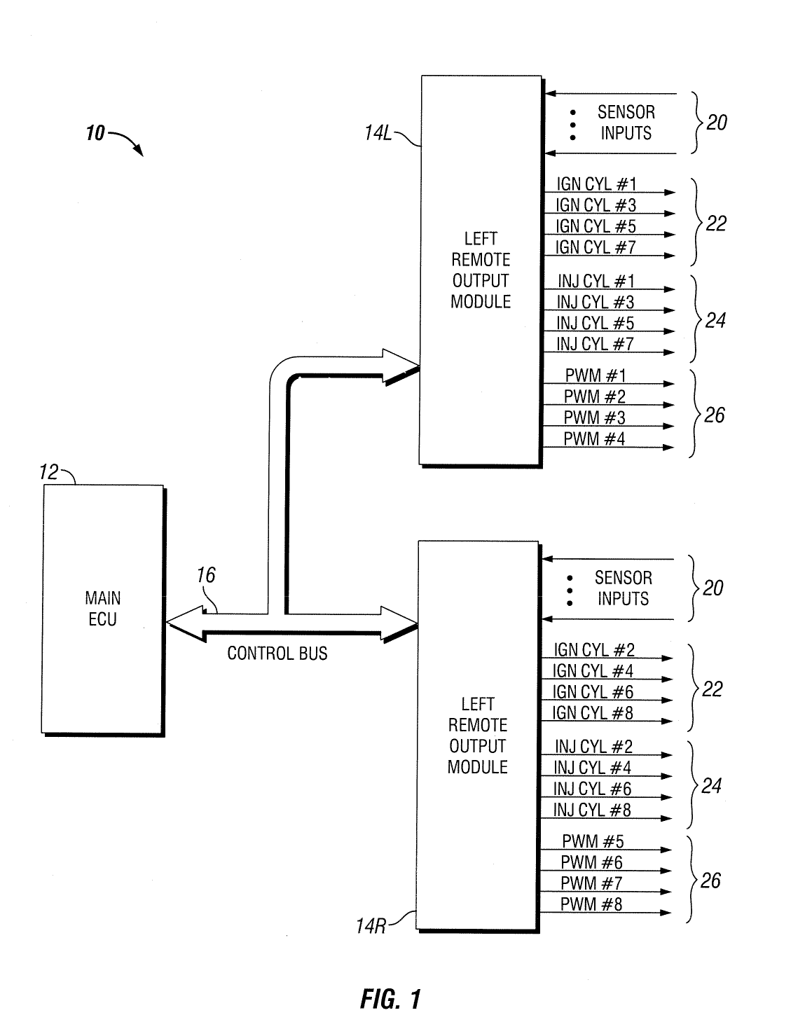

A decentralized EFI ECU system 10 with distributed processing for a V-8 engine is shown in FIG. 1. System 10 includes a main ECU module 12 and left and right bank remote input/output modules 14L, 14R. Each remote module includes one or more input channels 20 for sensor inputs, four ignition outputs 22, and four fuel injector outputs 24. Additionally, each remote module may optionally include a number of pulse width modulation (PWM) outputs 26, which may be used for electronic throttle control, variable valve timing, or idle air motor actuation, for example. A bidirectional ECU control bus 16, as described below, operatively connects main ECU 12 to left and right bank remote modules 14L, 14R.

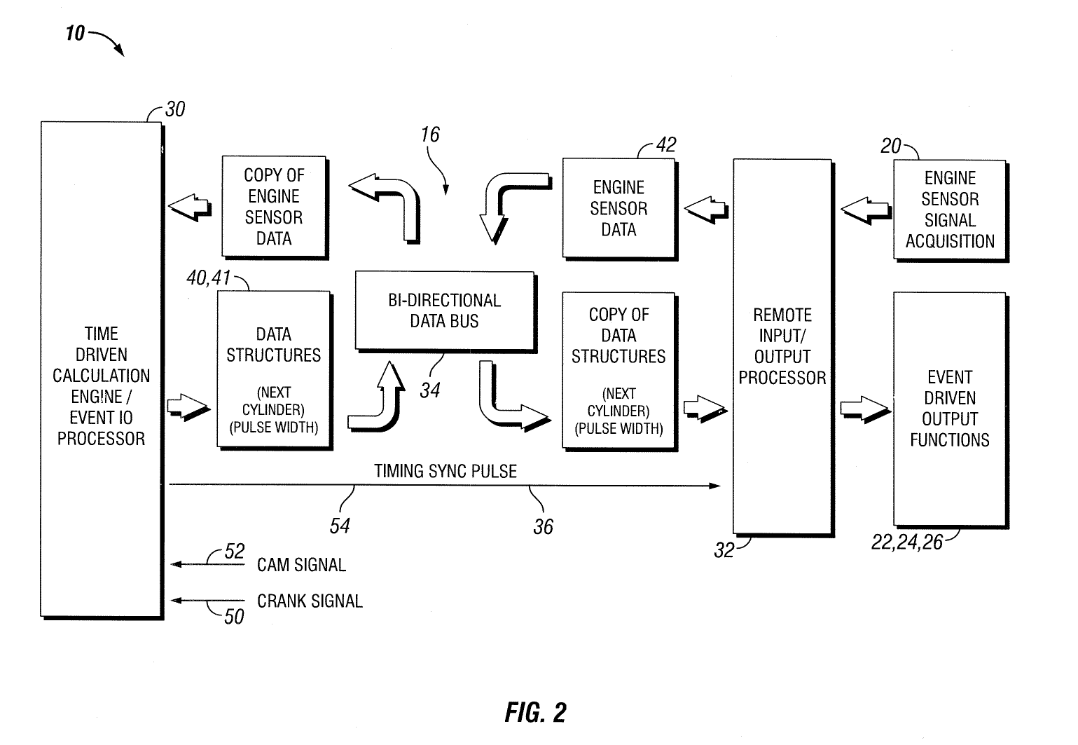

FIG. 2 illustrates the basic topology of the distributed ECU system 10. One or more remote processors 32 (of the left or right bank remote module 14L, 14R, for example) receive signals 20 from various engine sensors and encode the sensor data into various sensor data structures, or messages, 42. Engine sensor data 42 is transmitted via a bi-directional CAN data bus (or similar asymmetric data bus) 34 from remote processor(s) 32 to the control processor 30 of main ECU module 12. Control processor 30 also receives engine position data directly from crank and cam signal inputs 50, 52, respectively. The control processor 30 processes this cam, crank and sensor data and generates the required control data structures, or messages, 40 and output timing signal 54. The control data structures 40 are transmitted via the bi-directional CAN data bus 34 back to the remote processor(s) 32. The timing signal 54, generated by the control processor 30, is transmitted via a timing conductor 36 that is separate from the asynchronous data bus 34, thereby providing real-time synchronizing, or triggering, data independently of the non-deterministic data bus 34. The remote processor(s) 32 processes the control messages 40 and timing signal 54 carried by data bus 34 and timing conductor 36, respectively, and generates the appropriate ignition output signal 22, injector output signals 24, and control output signals 26, as described in greater detail below.

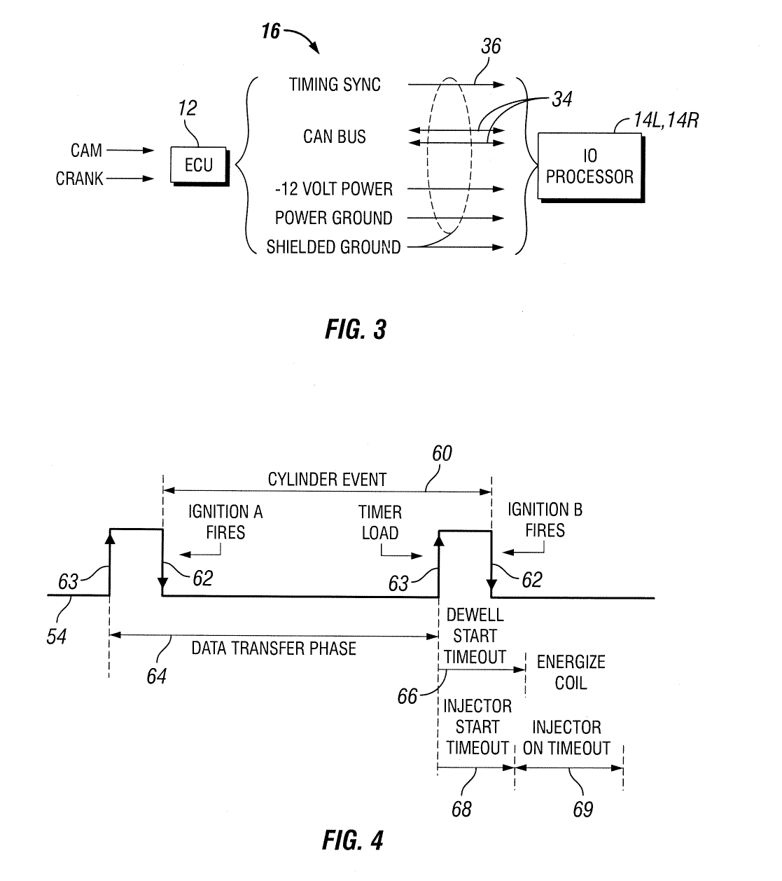

FIG. 3 is a wiring schematic of the bidirectional ECU control bus 16 according to a preferred embodiment of the invention. The bi-directional CAN data bus 34 and the timing signal conductor 36 are combined with the necessary power and ground inputs to form the control bus 16 utilized to interconnect the main ECU 12 and the remote modules 14L, 14R. These conductors may be harnessed or cabled together, and they may, for example, be combined in a harness with additional conductors as appropriate, such as those wires carrying crank and cam signal inputs 50, 52, respectively.

The control protocol is divided into two sections. The first section, synchronous protocol, is synchronized to the rotation of the engine (using crank and cam signal inputs 50, 52) and is used to control the normal firing of the ignitions and injectors via outputs 22, 24. The second section, asynchronous protocol, is either time-driven or non-repetitive-event-driven. The time-driven events are used to scan the sensor inputs 20 and to update the various outputs such as the PWM driver outputs 26. The non-repetitive events are used for special purposes such as accelerator pump functions.

Synchronous Control Protocol

As was discussed above, the control data structures 40 and the ignition and injector timing signal 54 generated by the main EFI ECU 12 are transferred to the remote modules 14L, 14R via the bi-directional CAN data bus 34 and the timing signal conductor 36. To accomplish this process, the data structures 40 and timing signal 54 are broken down into individual cylinder events. Each of these cylinder events are considered independently and are then connected together into a continuous string to generate the overall EFI process.

Referring now to FIG. 4, a cylinder event 60 is defined as that period of time from the firing of one ignition coil to the firing of the next ignition coil. In a V-8 engine this represents 90 degrees of engine rotation. A new cylinder event 60 starts at the time the last ignition coil is fired. The ignition coil is fired on the falling edge 62 of the timing sync signal 54. The timing sync signal 54 is used to frame each cylinder event 60 and to divide the event 60 into the required phases utilized to transfer and execute the control instructions 40 (FIG. 2).

A data transfer phase is defined from rising edge 63 to rising edge 63 of the timing signal 54. That is, the data transfer phase actually begins on the rising edge of the previous cylinder event 60. This arrangement provides an entire cylinder cycle in which to transmit the required control data 40. In most cases, the data will be transferred later in the phase to allow the most recent information to be utilized.

The rising edge 63, sometimes referred to herein as the Timer Load, acts as a trigger to start timing various events other than firing the ignition (which is triggered by falling edge 62). During the data transfer phase, 64, the control information required during this cylinder event is transferred via the CAN bus to the remote processor(s) 32. This information includes the next ignition coil(s) to energize, the next ignition coil to fire, the time delay 66 from Timer Load 63 to start of dwell, the next injector(s) to energize, the delay time 68 from Timer Load 63 to turn the injector(s) on, and the required injector “on” time 69. The information may also include the a safety fire time delay.

This information may be transferred using two structured CAN messages 40 (FIG. 2). The first of these messages 40 is the Next Ignition Cycle message, which includes both the information of the next cylinder to fire and the next ignition coil to energize or start of dwell 66. The message 40 also includes the maximum dwell time in 10 μs ticks for the coil to be energized. This time is used to ensure the coil is fired at a safe point in the engine rotation should the timing sync signal fail. The resolution is may be safely varied, so long as the main ECU 12 and remote modules 14L, 14 R are synchronized. The format of the Next Ignition Cycle message 40 is as follows:

Next Ignition Cycle Message CAN ID = 0x100

| Data Byte | Value Range | Parameter |
|---|---|---|
| 0, lower nibble | 0-15 | Next cylinder to fire (0 = none) |
| 0, upper nibble | 0-15 | Next cylinder to dwell (0 = none) |
| 1-2 | 0-65535 | Dwell start delay (10 μs increment) |
| 3-4 | 0-255 | Safety coil fire delay time (10 μs |
| | | increment) |

The second of these messages 40 is the Next Injection Cycle message, which includes the information required to determine the start of the injection cycle based on an injector timeout delay 68 from the Timer Load 63, the injector “On” time 69 from injection start, and which injectors to utilize. The format of the Next Injection Cycle message 40 is as follows:

Next Injection Cycle Message CAN ID = 0x110

| Data Byte | Value Range | Parameter |
|---|---|---|
| 0 | 0-255 | Type of injection cycle (future development) |
| 1-3 | | 24 bit injector mask |
| 4-5 | 0-65535 | Start of injection delay (10 μs increment) |
| 6-7 | 0-65535 | Injector On time (10 μs increment) |

In the Next Injection Cycle message 40 an injector mask rather than a specific injector to fire is utilized. This allows multiple injectors to be turned on at the same time in applications with multiple injectors per cylinder or in the case of bank fire applications. In addition the start of injection delay may have a minimum value to ensure timer values are properly loaded due to the structure of the software timers in some application software packages.

At lower engine speeds, only one Next Ignition Cycle message 40 and one Next Injection Cycle message 40 need to be transmitted during each cylinder event 60. In some cases, however, a second instance of these control messages 40 must be transmitted during a single cylinder event 60. This mainly occurs with respect to the Next Ignition Cycle message 40 due to the required fixed dwell time 66 of the ignition coils. As the engine rpm increases, there are points where the start of dwell must jump into an earlier cylinder cycle 60. On each of these transitions two Next Ignition Cycle Messages 40 must be sent. In this case the next cylinder to fire should be repeated in both messages. This may also occur with the Next Injection Cycle message if a shift in the starting point of injection must be moved earlier in the engine rotation to accommodate longer injection times.

The timer load phase commences on the rising edge 63 of the timing sync signal 54. The control information 40 received by the remote modules 14L, 14R (FIG. 1) during the data transfer phase 64 is transferred during the timer load phase from temporary receive data structures into actual ignition control and injector and dwell timer structures. As soon as the timers 66, 68, 69 are loaded, they begin to time out the individual dwell and injection timing sequences. At this point, these sequences are strictly time-based, are independent of any future or past cylinder event information, and can persist through multiple cylinder events cycles 60.

The final phase of the cylinder event or ignition trigger phase occurs on the falling edge 62 of the timing signal 54. Immediately on the falling edge 62, the ignition coil designated in the most recent Next Ignition Cycle message 40 is fired. This completes the cylinder event cycle 60. The process is then repeated for each subsequent cylinder event 60. In a preferred embodiment, only one cylinder is fired per falling edge 62. However, potentially two cylinders may be fired, for example, in a “limp-home” mode in the case of a missing cam sensor signal 52.

The falling edge 62 of the timing signal 54 is dictated by the actual spark advance required for a given cylinder. The rising edge 63 (timer load), however, is under the control of the main EFI ECU 12 and can either be fixed or varied relative to the crank position from cycle to cycle. The only limitations are that the data transmission phase 54 be of sufficient duration for the required data to be transmitted, the dwell and injector start delays 66, 68 be calculated appropriately, and the time between the rising and falling edges 63, 62 be sufficient for the loading process to complete.

Alternate Synchronous Control Protocol

The Remote EFI Protocol discussed above with respect to system 10 utilizes CAN messaging 40 plus a timing synchronization signal 54 to transfer the required fuel injection and ignition information from the main ECU 12 to the remote units 14L, 14R mounted directly on the engine. A system according to an alternative embodiment of the invention eliminates the need for the timing signal 54 and uses only the CAN messaging 40. This alternative uses time stamp capabilities of the CAN bus topology to synchronize the main ECU processor 12 with the remote 14L, 14R units. It should be noted, however, that not all CAN hardware provides the proper time stamp capability. Care must be taken in selecting compatible hardware.

To accomplish the synchronization between the main and the remote processors, the main ECU processor 12 sends two timing messages to the remote units 14L, 14R. The first timing message sent is the sync command. When the sync command is sent, the CAN hardware creates a first time stamp of the exact time the message was sent by the main ECU processor 30 and a separate time stamp of when the message was received by each of the remote unit processors 32. The main processor 30 then sends a second timing message containing the first time stamp data that was generated on the transmission of the sync command. The remote unit processors 32 each compare the first time stamp data in the second message from the main processor 30 and their own time stamp data generated when the sync command was received. The difference between the two time stamps is then used to synchronize the time base of the remote processors 32 to the main processor 30. This synchronization process is repeated periodically to correct for any differences in the clock timing between the main and remote units.

Once the main and remote processors 30, 32 are synchronized, the main processor 30 can then issue injector and ignition commands 40 to the remote units including the specific clock time at which to execute the commands.

The command messages sent would be somewhat different as the messages would contain the execution time rather than a time out delay to be measured from the rising edge 63 of the timer signal 54. As an example the following Next Ignition Cycle and Next Injection Cycle messages 40 might be utilized.

Next Ignition Cycle Message CAN ID = 0x100

| Data Byte | Value Range | Parameter |
|---|---|---|
| 0, lower nibble | 0-15 | Next cylinder to fire (0 = none) |
| 0, upper nibble | 0-15 | Next cylinder to dwell (0 = none) |
| 1-3 | 0-65535 | Fire clock value |
| 4-6 | 0-65535 | Dwell Start clock value |
| 7 | | Safety coil fire delay time (500 μs |
| | | increment) |

Next Injection Cycle Message CAN ID = 0x110

| Data Byte | Value Range | Parameter |
|---|---|---|
| 0-2 | | 24 bit injector mask |
| 3-4 | 0-255 | Injector on time (10 μs increment) |
| 5-7 | 0-65535 | Injection Start clock value |

The clock values indicated refer to the main time base of the central processor. The Safety coil fire delay time is measured from the Dwell Start clock value.

Asynchronous Control Protocol

The asynchronous control protocol refers to those portions of the protocol that are not synchronized to the rotation of the engine but rather are time- or random-event-driven. Items such as reading of the sensor values 20, updating of the PWM controllers, and accelerator pump functions fall into this category. As such, the asynchronous control protocol is implemented entirely on the bi-directional CAN data bus 34. The current elements of the protocol include sensor input messages 42 and control output messages 41 (FIG. 2).

Sensor Input Messages

The sensor input messages 42 are transmitted from the remote modules 14L, 14R to the main ECU 12 via the CAN bus 34. The sensor input messages 42 are time-driven and are divided into three groups according to their required update rates—High Speed (2 ms update), Standard Speed (10 ms update), and Low Speed (1 s update). However, significant changes in the message format and update rates can be easily accommodated, and the actual contents of these messages 42 may be varied as appropriate.

Sensor Input Messages

| | Remote | | Update |
|---|---|---|---|
| CAN ID | Module No. | Message Name | Speed |
| 0x300 | 1 | High Speed Sensor Data | 2 ms |
| 0x310 | 2 | | |
| 0x320 | 1 | Standard Speed Sensor Data | 10 ms |
| 0x330 | 2 | | |
| 0x340 | 1 | Slow Speed Sensor Data | 1 s |
| 0x350 | | | |

The high speed sensor messages are the highest priority messages 42 transmitted from the remote modules 14L, 14R to the main ECU 12. High speed messages 42 can be transmitted by either or both of the remote I/O modules 14L, 14R. Although a separate high speed message can be transmitted from each of the remote I/O modules, if possible the hardware design topology should be organized to allow a single high speed message to be transmitted due to bandwidth constraints. A content byte may used to validate values in a given message. Exemplary format and contents of the high speed messages 42 are listed in the following tables. However, significant changes in the format and content of these messages may be accommodated as appropriate.

Left Bank High Speed Message CAN ID = 0x300

| Data Byte | Data Range | Parameter |
|---|---|---|
| 0 | | Content Byte plus O₂ |
| Bit 0 | 0-1 | Narrow Band O2B1 Valid |
| Bit 1 | 0-1 | Narrow Band O2B2 Valid |
| Bit 2 | 0-1 | Throttle Position 1 Valid |
| Bit 3 | 0-1 | Throttle Position 2 Valid |
| Bit 4 | 0-1 | Injector Voltage Valid |
| Bit 5 | 0-1 | Reserved |
| Bit 6 | 0-1 | Narrow Band O2B1 State |
| Bit 7 | 0-1 | Narrow Band 02B1 State |
| 1 | 0-255 | Reserved |
| 2-3 | 0-4096 | Left Bank Throttle Position 1 Value |
| 4-5 | 0-4096 | Left Bank Throttle Position 2 Value |

Right Bank High Speed Message CAN ID = 0x310

| Data Byte | Data Range | Parameter |
|---|---|---|
| 0 | | Content Byte plus O₂ |
| Bit 0 | 0-1 | Narrow Band O2B1 Valid |
| Bit 1 | 0-1 | Narrow Band O2B2 Valid |
| Bit 2 | 0-1 | Throttle Position 1 Valid |
| Bit 3 | 0-1 | Throttle Position 2 Valid |
| Bit 4 | 0-1 | Injector Voltage Valid |
| Bit 5 | 0-1 | Reserved |
| Bit 6 | 0-1 | Narrow Band O2B1 State |
| Bit 7 | 0-1 | Narrow Band 02B1 State |
| 1 | 0-255 | Reserved |
| 2-3 | 0-4096 | Right Bank Throttle Position 1 Value |
| 4-5 | 0-4096 | Right Bank Throttle Position 2 Value |

The second highest priority sensor messages 42 to be transmitted from the remote modules 14L, 14R to the main ECU 12 use the standard speed message format for transmitting the 10 ms update data channels. Standard speed sensor messages 42 may be transmitted by both of the remote engine I/O modules 14L, 14R. Exemplary format and contents of the standard speed messages 42 are listed in the following tables. However, significant changes in the format and content of these messages may be accommodated as appropriate.

Left Bank Standard Speed Message CAN ID = 0x320

| Data Byte | Data Range | Parameter |
|---|---|---|
| 0 | 0-255 | Fuel Pressure raw value (low byte) |
| 1 | 0-255 | Fuel Pressure raw value (high byte) |
| 2 | 0-255 | Left Bank Bat Volt raw value (low byte) |
| 3 | 0-255 | Left Bank Bat Volt raw value (high byte) |
| 4 | 0-255 | Reserved |
| 5 | 0-255 | Reserved |
| 6 | 0-255 | Reserved |
| 7 | 0-255 | Reserved |

Right Bank Standard Speed Message CAN ID = 0x330

| Data Byte | Data Range | Parameter |
|---|---|---|
| 0 | 0-255 | Manifold Abs Pressure Raw Value (low Byte) |
| 1 | 0-255 | Manifold Abs Pressure Raw Value (high byte) |
| 2 | 0-255 | Right Bank Bat Volt raw value (low byte) |
| 3 | 0-255 | Right Bank Bat Volt raw value (high byte) |
| 4 | 0-255 | CAM Position Sensor Raw Value |
| 5 | 0-255 | AC On Input Raw Value |
| 6 | 0-255 | Reserved |
| 7 | 0-255 | Reserved |

The lowest priority sensor messages 42 to be transmitted from the remote modules 14L, 14R to the main ECU 12 are used to transmit the 1 s update data channels. These slow speed messages 42 are transmitted by both of the remote engine I/O modules 14L, 14R. A content byte may used to validate values in a given message. Exemplary format and contents of the slow speed messages 42 are listed in the following tables. However, significant changes in the format and content of these messages may be accommodated as appropriate.

Left Bank Slow Speed Message CAN ID = 0x340

| Data Byte | Data Range | Parameter |
|---|---|---|
| 0 | 0-255 | Engine Coolant Temp Raw Value (low byte) |
| 1 | 0-255 | Engine Coolant Temp Raw Value (high byte) |
| 2 | 0-255 | Oil Pressure Raw Value |
| 3 | 0-255 | Left Bank Module Temperature |
| 4 | 0-255 | Reserved |
| 5 | 0-255 | Reserved |
| 6 | 0-255 | Reserved |
| 7 | 0-255 | Reserved |

Right Bank Slow Speed Message CAN ID = 0x350

| Data Byte | Data Range | Parameter |
|---|---|---|
| 0 | 0-255 | Content Byte |
| 1 | 0-255 | Intake Air Temperature Raw Value |
| 2 | 0-255 | Reserved |
| 3 | 0-255 | Right Bank Module Temperature |
| 4 | 0-255 | Reserved |
| 5 | 0-255 | Reserved |
| 6 | 0-255 | Reserved |
| 7 | 0-255 | Reserved |

Control Output Messages

Asynchronous control output messages 41 are transmitted from the main ECU 12 to the remote modules 14L, 14R via the CAN data bus 34. Some of these control output messages 41 are time-driven, which are subdivided into two groups according to their required update rates—High Speed (2 ms update) and Standard Speed (10 ms update). Others, such as the accelerator pump control message, are event-driven. However, significant changes in the message format and update rates can be easily accommodated, and the actual contents of messages 41 may be varied as appropriate.

Control Output Messages

| CAN ID | Message Name | Update Speed |
|---|---|---|
| 0x200 | ETC PWM High Speed Control Output | 2 ms |
| 0x210 | PWM Standard Speed Control Output | 10 ms |
| 0x220 | Accelerator Pump Control Output | event-driven |

The high speed control output message 41 is transmitted from the main ECU 12 to the remote modules 14L, 14R and is used to transmit the 2 ms update data. The high speed control output message 41 is used to set the pulse width modulation for the electronically controlled throttles (ETC) on the engine. Exemplary format and contents of the high speed control output message 41 is listed in the following table. However, significant changes in the format and content of this message may be accommodated as appropriate.

ETC PWM High Speed Control Output CAN ID = 0x200

| Data Byte | Data Range | Parameter |
|---|---|---|
| 0, Bit 0 | 0-1 | PWM Enable |
| 0, Bit 1 | 0-1 | PWM Direction (0 = CW 1 = CCW) |
| 1-2 | 0-4096 | 12 bit PWM value for ETC Controllers |

Note that both left and right remote modules 14L, 14R receive this message and in response output the requested PWM waveforms 26. Accordingly, the hardware design must determine the implementation of the PWM functionality.

Similarly, the standard speed control output message 41 is transmitted from the main ECU 12 to the remote modules 14L, 14R and is used to transmit the 10 ms update data. The standard speed control output message is used to set the pulse width modulation for the various control devices on the engine, including the idle air control (IAC) and variable cam controllers. Exemplary format and contents of the standard speed control output message is listed in the following table. However, significant changes in the format and content of this message may be accommodated as appropriate.

PWM Standard Speed Control Output CAN ID = 0x210

| Data Byte | Data Range | Parameter |
|---|---|---|
| 0, Bit 0 | 0-1 | PWM Enable |
| 0, Bit 1 | 0-1 | PWM Direction (0 = CW 1 = CCW) |
| 0, Bit 2 | 0-1 | Alternator Output Control (1 = On 0 = Off) |
| 1 | 0-255 | Reserved |
| 2-3 | 0-200 | Stepper Value IAC Controller |
| 4-5 | 0-4096 | Cam Shaft PWM Controller |
| 6 | 0-255 | Reserved |
| 7 | 0-255 | Reserved |

Note as both remote modules 14L, 14R receive control output messages and output the requested PWM waveforms, it is up to the hardware design to determine the implementation of PWM functionality.

The final message 41 in the asynchronous output control message group is the accelerator pump output control message 41. This message is sent from the main ECU 12 to the remote modules 14L, 14R on an as-needed basis. Predictably, the accelerator pump output control message 41 provides the control information required to implement the accelerator pump functionality. Exemplary format and contents of the accelerator pump control output message 41 is listed in the following table. However, significant changes in the format and content of this message may be accommodated as appropriate.

Accelerator Pump Control Output CAN ID = 0x220

| Data Byte | Data Range | Parameter |
|---|---|---|
| 0 | 0 | Accel Pump Mode (always 0) |
| 1-3 | | 24 bit injector mask |
| 4-5 | 0-65535 | Injector Pulse Time (10 μsec resolution) |
| 6-7 | 0-65535 | Injector Stretch Time (10 μsec resolution) |

The injector bit mask is the same as the bit mask in the next injection cycle message 40, described above, and allows any combination of injectors to be fired to provide the extra fuel required by the engine. Two time values are provided—the injector pulse time and the injector stretch time. The two time values are required to allow the same amount of additional fuel to be delivered by each of selected injectors. If the selected injector is in the off state, an additional injector pulse is generated with a pulse width equal to the injector pulse time. If the injector is in the on state, the current injector cycle is extended by an amount of time equal to the injector stretch time.

There is one potential issue with the selection of the injectors to utilize with the accelerator pump function. If one of the injectors selected is the same as the injector selected in the normal “next injection cycle” described above, the accelerator pulse can be shorter than expected as the next injector to fire is forced off at the timer load phase 63, terminating the accelerator pulse function. This should not be a problem, however, as the calculated pulse width for the next injection cycle should contain the additional fuel required for the current engine conditions.

Software

The software for EFI system 10 includes drivers to implement the standard ignition and injector waveforms required to control the operation of the engine. These drivers may require modification to provide the necessary timing signal 54 and synchronous control messages 40 required by the left and remote modules 14L, 14R. As the control techniques of the present disclosure are designed to exist in parallel with a standard EFI topology (the software and hardware of the main ECU 12 are the same), any required change should be minimal. The required driver changes may include:

Timing Synchronization Signal Rising Edge Generation

The rising edge 63 of the timing sync signal 54 must be synchronized to the angular position of the engine in the same manner as the start of dwell in a typical single coil ignition system. The drivers required to accomplish this function may already exist. If they do not, a special driver must be generated to provide an interrupt service routine to be entered at a specific engine angular position. This routine would simply set the timing sync signal high. Optionally the routine could schedule the sending of the synchronous CAN control messages 40 discussed next.

Synchronous CAN Control Messages

The Next Ignition Cycle and Next Injection Cycle messages 40 must be sent after one rising edge 63 and before the next rising edge 63 of the timing signal 54. The most important aspect is to ensure the most recent/accurate information is transmitted. This implies sending control messages 40 later in the cycle. A variety of different methods can be used to accomplish this task. One method would utilize an interrupt service routine to be entered at a specific angular position similar to the routine discussed above. A second method would be to schedule the transmission from the interrupt service routine used to generate the rising edge 63 of the timing signal 54. The specific method utilized will largely depend on the driver capabilities of the implementing software.

Timing Sync Signal Falling Edge Generation

The following edge 62 of the timing signal 54 represents the actual firing of the ignition in the remote engine modules 14L, 14R. As such, existing ignition drivers can be modified to fire both the standard ignition port pin as well as to lower the timing signal line. No further modification should be necessary.

The Abstract of the disclosure is written solely for providing the United States Patent and Trademark Office and the public at large with a way by which to determine quickly from a cursory reading the nature and gist of the technical disclosure, and it represents solely a preferred embodiment and is not indicative of the nature of the invention as a whole.

While some embodiments of the invention have been illustrated in detail, the invention is not limited to the embodiments shown; modifications and adaptations of the above embodiment may occur to those skilled in the art. Such modifications and adaptations are in the spirit and scope of the invention as set forth herein:

What is claimed is:

1. A system for controlling at least one of the group consisting of an ignition system and a fuel injection system of an internal combustion engine comprising:
a first processor unit operatively coupled to a sensor that indicates crankshaft position of said engine;
a second processor unit remotely located from said first processor unit and operatively coupled to at said at least one of the group consisting of said ignition system and said fuel injection system for actuation thereof; and
an engine control bus interconnecting said first and second processor units.

2. The system of claim 1 wherein:
said engine control bus includes a bidirectional asynchronous data bus interconnecting said first and second processor units;
said first processor unit is designed and arranged to transmit at least one of the group consisting of ignition control data and fuel injection control data to said second processor unit via said asynchronous data bus; and
said second processor unit is designed and arranged to control said at least one of the group consisting of said ignition system and said fuel injection system in synchronization with said crankshaft position based on said at least one of the group consisting of said ignition control data and said fuel injection control data.

3. The system of claim 2 wherein:
said asynchronous data bus is a controller area network bus.

4. The system of claim 2 further comprising:
a transmitter coupled to said asynchronous data bus that is designed and arranged to produce a first timestamp when a first timing message is transmitted over said asynchronous data bus by said transmitter; and
a receiver coupled to said asynchronous data bus that is designed and arranged to produce a second timestamp when said transmitted first timing message is received by said receiver;
whereby a second timing message that includes said first timestamp may be transmitted by said transmitter to said receiver via said asynchronous data bus; and
a comparison of said first and second timestamps allows said clocks of first and second processor units to synchronize.

5. The system of claim 4 wherein:
said at least one of the group consisting of said ignition control data and said fuel injection control data include a clock value; and
said second processing unit controls said at least one of the group consisting of said ignition system and said fuel injection system triggered from when said clock of said second processing unit equals said clock value.

6. The system of claim 4 wherein:
said ignition control data includes a first value designating a particular cylinder of said engine to fire and a second value designating a time to fire said particular cylinder; and
said second processing unit causes ignition in said particular cylinder based on when said clock of said second processing unit equals said second value.

7. The system of claim 4 wherein:
said ignition control data includes a first value designating a particular cylinder of said engine to dwell and a second value designating a time to dwell said particular cylinder; and
said second processing unit causes said particular cylinder to dwell based on when said clock of said second processing unit equals said second value.

8. The system of claim 4 wherein:
said fuel injection control data includes a first value designating a particular fuel injector of said engine and a second value designating a time to energize said particular fuel injector; and
said second processing unit causes said particular fuel injector to be energized based on when said clock of said second processing unit equals said second value.

9. The system of claim 2 wherein:
said engine control bus further includes a timing conductor connecting said first and second processor units;
said first processor unit is designed and arranged to transmit a timing signal to said second processor unit via said timing conductor; and
said second processor unit is designed and arranged to control said at least one of the group consisting of said ignition system and said fuel injection system based on said at least one of the group consisting of said ignition control data and said fuel injection control data and triggered so as to be in synchronization with said crankshaft position by said timing signal.

10. The system of claim 9 wherein:
said asynchronous data bus is a controller area network bus.

11. The system of claim 9 wherein:
said timing signal is a periodic square wave;
one of the group consisting of a rising edge and a fall edge of a pulse of said square wave defines a trigger event;
said at least one of the group consisting of said ignition control data and said fuel injection control data include a time delay value; and
said second processing unit controls said at least one of the group consisting of said ignition system and said fuel injection system based on an elapsed time measured from said trigger event equal to said time delay value.

12. The system of claim 11 wherein:
said ignition control data includes a first value designating a particular cylinder of said engine to fire and a second value designating a delay time to fire said particular cylinder; and
said second processing unit causes ignition in said particular cylinder at an elapsed time measured from said trigger event equals said second value.

13. The system of claim 11 wherein:
said ignition control data includes a first value designating a particular cylinder of said engine to dwell and a second value designating a time to dwell said particular cylinder; and
said second processing unit causes said particular cylinder to dwell at an elapsed time measured from said trigger event equals said second value.

14. The system of claim 11 wherein:
said fuel injection control data includes a first value designating a particular fuel injector of said engine and a second value designating a time to energize said particular fuel injector; and
said second processing unit causes said particular fuel injector to be energized at an elapsed time measured from said trigger event equals said second value.

15. The system of claim 2 wherein:
said second processor unit is designed and arranged to transmit sensor data to said first processor unit via said asynchronous data bus contemporaneously with said transmission of said at least one of the group consisting of said ignition control data and said fuel injection control data; and
said first processor unit is designed and arranged to transmit asynchronous control data that is independent of said crankshaft position to said second processor unit via said asynchronous data bus contemporaneously with said transmission of said at least one of the group consisting of said ignition control data and said fuel injection control data.

16. The system of claim 15 wherein:
said asynchronous control data relates to one from the group consisting of pulse width modulation control and accelerator pump function.

17. A method for controlling at least one of the group consisting of an ignition system and a fuel injection system of an internal combustion engine comprising the steps of:
providing first and second processor units, said second processing unit being remotely located from said first processing unit;
operatively coupling said first processor unit to a sensor that indicates crankshaft position of said engine;
operatively coupling said second processor unit to at least one of the group consisting of said ignition system and said fuel injection system for actuation thereof; and
interconnecting said first and second processor units using an engine control bus.

18. The method of claim 17 further comprising the steps of:
providing a bidirectional asynchronous data bus within said engine control bus;
transmitting at least one of the group consisting of ignition control data and fuel injection control data from first processor unit to said second processor unit via said asynchronous data bus; and
controlling said at least one of the group consisting of said ignition system and said fuel injection system in synchronization with said crankshaft position based on said at least one of the group consisting of said ignition control data and said fuel injection control data.

19. The method of claim 18 further comprising the steps of:
transmitting a first timing message over said asynchronous data bus;
producing a first timestamp that indicates the time of a first processor clock when said first timing message is transmitted;
receiving said transmitted first timing message;
producing a second timestamp that indicates the time of a second processor clock when said transmitted first timing message is received;
comparing said first and second timestamps;
synchronizing said first and second processor clocks and based on said step of comparing;
including in said at least one of the group consisting of said ignition control data and said fuel injection control data include a clock value; and
controlling by said second processing unit said at least one of the group consisting of said ignition system and said fuel injection system triggered from when said synchronized first and second processor clocks equal said clock value.

20. The method of claim 18 further comprising the steps of:
providing a timing conductor within said engine control bus;
transmitting a timing signal to said second processor unit via said timing conductor from said first processor unit;
including in said at least one of the group consisting of said ignition control data and said fuel injection control data a time delay value; and
controlling by said second processing unit said at least one of the group consisting of said ignition system and said fuel injection system based on an elapsed time equal to said time delay value measured from a triggering event defined by said timing signal.
